(19) United States
(12) Patent Application Publication
(10) Pub. No.: US 2011/0052447 A1
(43) Pub. Date: Mar. 3, 2011

(54) Detection System for Detecting and Measuring Metal Ions in an Aqueous Medium

(76) Inventors: Eric G. Roy, Bangor, ME (US); Carl P. Tripp, Orono, ME (US); Mark L. Wells, Orono, ME (US)

(21) Appl. No.: 12/918,658

(22) PCT Filed: Feb. 17, 2009
(86) PCT No.: PCT/US2009/034275

§ 371 Date: Oct. 25, 2010

Related U.S. Application Data
(60) Provisional application No. 61/066,602, filed on Feb. 21, 2008.

(51) Int. Cl. G01N 21/25

(52) U.S. Cl. 422/82.05

(57) ABSTRACT

A detection system for detecting and measuring a metal ion in an aqueous medium includes a substrate that provides mechanical stability and is sized and shaped to intercept an optical beam (for example, a beam in the ultraviolet, visible or infraredregion). A reactive material is attached to the substrate, for example attached to the surface of the substrate or to a film that coats the substrate. The reactive material is capable of reacting with the metal ion and changing its optical spectrum upon reacting. For example, in one embodiment the reactive material includes a chelator that bonds to the metal ion to form a chelate complex. The detection system also includes an optical spectrometer producing the optical beam that passes through the reactive material to a detector of the spectrometer. For example, the spectrometer may be a Fourier transform, dispersive or filter based spectrometer. The changing of the optical spectrum of the reactive material allows the spectrometer to detect and measure the metal ion.

### BACKGROUND OF THE INVENTION

This invention relates in general to analytical methods and instruments for detecting and measuring trace metal ions in an aqueous medium.

All known forms of aquatic life have a fundamental requirement for metals, as they act as cofactors for a number of cellular processes. Amongst the various bioactive trace metal ions, iron is of particular interest for environmental scientists and oceanographers. In upwards of 40% of the world's ocean, photosynthetic carbon dioxide drawdown by marine phytoplankton is limited by the amount of dissolved iron in surface waters. Therefore, iron biogeochemistry in the ocean has significant implications for climate change, by regulating carbon dioxide flux at the air/sea interface. Although iron limitation in subarctic Pacific, equatorial Pacific and Southern Ocean surface waters is now well demonstrated, the effect of iron inputs on the carbon cycle is poorly quantified, mostly due to the paucity of field measurements. Recently, autonomous gliders, depth profilers, and buoy networks have been outfitted with sensors to provide time series data for a number of oceanographic events, but the analytical difficulties in measuring trace metals have hindered the development of simple and deployable metal detection systems.

Measuring iron in seawater is extremely challenging from an analytical standpoint. Low open ocean iron concentrations (<1 nM) introduce numerous opportunities for contamination during sampling and analyses. The nature of marine chemistry also complicates the analytical process because the overwhelming majority of metal ions in seawater reside in strong organic complexes at equilibrium, and samples must be acidified to render the iron detectable. Measurements are further complicated by the seawater matrix, which contains about 3% salt and other elements that may interfere with trace metal analysis. For the most reliable analytical methods (e.g., Inductively Coupled Plasma Mass Spectrometry (ICP-MS), Graphite Furnace Atomic Absorption GF-AA)), these salts must first be separated from the metals using a chelating resin prior to elution to the downstream instrument. Moreover, ICP-MS and GF-AA are land-based methods, and the measurements cannot guide shipboard experiments. In the past 15 years, colorimetric and chemiluminescent techniques have been developed to measure trace metal ions on a shipboard platform, but these methods require rigorous sample treatment and a high level of user interaction and expertise.

Because making trace metal ion measurements in the ocean are prohibitively difficult, only about 50 research labs worldwide measure trace metal ions routinely. However, the overwhelming majority of seagoing oceanographers (about 2000 labs worldwide) would embrace simple technology to make trace metal ion measurements on research vessels. In addition to this, a detection system that operates without user interaction would quickly be added to each of the 7000 autonomous ocean sensing platforms that are currently deployed.

### SUMMARY OF THE INVENTION

This invention relates to a detection system for detecting and measuring a metal ion in an aqueous medium. The detection system comprises a substrate that provides mechanical stability and is sized and shaped to intercept an optical beam (for example, a beam in the ultraviolet, visible or infrared region). A reactive material is attached to the substrate, for example attached to the surface of the substrate or to a film that coats the substrate. The reactive material is capable of reacting with the metal ion and changing its optical spectrum upon reacting. For example, in one embodiment the reactive material comprises a chelator that bonds to the metal ion to form a chelate complex. A particular example of this is shown below in Scheme 1. The detection system also comprises an optical spectrometer producing the optical beam that passes through the reactive material to a detector of the spectrometer. For example, the spectrometer may be a Fourier transform, dispersive or filter based spectrometer. The changing of the optical spectrum of the reactive material allows the spectrometer to detect and measure the metal ion.

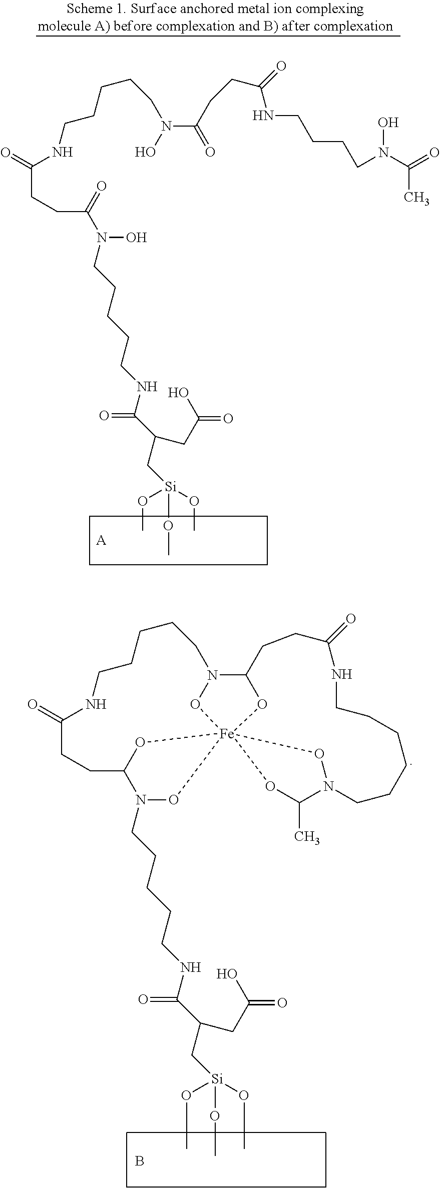

In a particular embodiment, the substrate of the detection system is transportable and disposable. For example, the substrate can be a silicon chip. In another embodiment, the detection system is included in apparatus for detecting and measuring a metal ion in seawater, which may be used on an ocean vessel or platform.

### DETAILED DESCRIPTION OF PARTICULAR EMBODIMENTS

The detection system of the invention uses a reactive material attached to a substrate, in combination with spectroscopic analysis, to detect and measure a metal ion in an aqueous medium. The metal ion to be detected may be any type found in an aqueous medium, such as iron, copper, nickel, lead, cadmium or cobalt in a sample of seawater. The aqueous medium may be seawater, freshwater, or any other medium that contains predominantly water.

The substrate provides mechanical stability to the combination of the substrate and the reactive material and it may also provide ease of handling of the combination. Any suitable material(s) can be used to make the substrate. A water insoluble substrate may be used. The material used may depend on which optical region and which spectroscopic mode are used in the detection system. For transmission spectroscopy, the material used to make the substrate is at least partially transparent in the spectral region of interest. For example, materials such as polymers, metal oxides and metal salts, as well as common infrared window materials such as silicon may be used for transmission infrared spectroscopy. For ultraviolet or visible transmission spectroscopy, materials such as quartz, glass or transparent polymers may be used. Infrared spectroscopy in photoacoustic and reflection modes may use the above-mentioned materials or opaque and/or reflective materials such as metals for the substrate. ATR infrared spectroscopy or fiber optic ultraviolet/visible spectroscopy may be performed using an internal reflection element called a crystal or a fiber optic as the substrate, which can be made from any suitable material such as Si, Ge, ZnSe, ZnS, diamond, sapphire, CaF₂ or BaF₂ for infrared spectroscopy, and glass, quartz or transparent polymers for ultraviolet or visible spectroscopy.

The substrate is sized and shaped to intercept an optical beam from the spectrometer. The size and shape of the substrate may vary considerably depending on the spectroscopy mode used in the detection system. In one embodiment the substrate is disposable. A disposable substrate may be suitable for use in most spectroscopic modes other than ATR infrared spectroscopy. For example, a disposable substrate for use in an infrared, ultraviolet or visible transmission mode may be a rounded, square or rectangular shaped chip or wafer having an area within a range of from about 0.1 mm² to about 10 cm² and a thickness within a range of from about 25 um to about 5 cm. The substrate may be sized and shaped for mounting in a standard or custom fabricated transmission holder of the spectrometer.

Alternatively, a crystal used as the substrate for ATR infrared spectroscopy may have an elongated rectangular or trapezoidal shape with beveled ends. The crystal can have any suitable size, for example, a length within a range of from about 0.5 cm to about 10 cm, a width within a range of from about 0.1 cm to about 3 cm, and a thickness within a range of from about 0.1 cm to about 1 cm. A fiber optic for ultraviolet or visible spectroscopy can have a length of many meters and a thickness within a range of 0.1 mm to about 1 cm.

In some embodiments the reactive material is attached directly to the substrate. In other embodiments, a material to facilitate the attachment or provide another benefit is applied to the substrate, and the reactive material is attached to that material. For example, the substrate may be coated with a layer of material such as a film to facilitate attachment of the reactive material to the substrate. The improved attachment can be by any suitable mechanism, such as adhesive and/or chemical attachment. Any suitable material can be used to facilitate the attachment.

In one embodiment, the material to which the reactive material is attached is a high surface area material such as a mesoporous silica film or porous polymer layer to increase the surface area of the substrate, so that a higher number of reactive material molecules are exposed to the metal ions in the aqueous medium. This can also be achieved by using a substrate that is porous so that the aqueous medium can pass through it.

A linker molecule can be used to modify the substrate or film surface, providing functional groups that can be used to attach a reactive material to the surface, such as carboxylic acid groups or aldehydes that can react with an amine. Some examples of chemicals that can act as a linker molecule include 3-(triethoxy-silyl) propylsuccinic anhydride, (3-aminopropyl)dimethylethoxylsilane, and triethyoxysilylbutyraldehyde. Alternatively, the reactive material can be directly attached to the substrate or film without the additional use of a linker.

The reactive material used in the detection system can be any material(s) capable of reacting with the metal ion and changing its optical spectrum upon reacting. The reactive material can have a high selectivity for a particular metal ion or it can have a general selectivity for metal ions. The reactive material can react with the metal ion in any suitable manner. In one embodiment, the reactive material is a chelator that bonds to the metal ion to form a chelate complex. Any suitable chelator can be used. For example, a class of molecules called siderophores have a high selectivity for iron. Scheme 1 above shows a siderophore called desferrioxamine B (DFB) attached to the surface of a substrate before (A) and after (B) complexation with an iron ion. Another example of a chelator is 8-hydroxyquinoline which has a general selectivity for metal ions.

The reaction of the reactive material with the metal ion alters the reactive material. In one embodiment the reactive material on the substrate can be regenerated in any suitable manner, for example by washing the substrate with a rinse solution, allowing the reactive material/substrate to be reused many times. In another embodiment, the alteration of the reactive material is irreversible, for example by the chelator complexing the metal ion irreversibly, and the reactive material/substrate in only used a single time.

The reactive material, and optionally the material which facilitates the attachment of the reactive material, can be applied to the substrate by any suitable method. For example, they can be coated on the surface of the substrate by any physical and/or chemical coating method. An example of a dry coating method includes mixing with a binder and pressing onto the substrate. Examples of wet coating methods include casting, spraying or spin coating. They may also be applied to the substrate using chemical/physical deposition or vacuum sublimation techniques. The coating can have any suitable thickness, which can vary widely depending on a particular application. In one embodiment, the coating is a relatively thin film having a thickness within a range of from about 0.1 nanometer to about 500 microns, and more particularly from about 0.2 micron to about 10 microns.

The detection system also includes an optical spectrometer producing an optical beam that passes through the reactive material to a detector of the spectrometer. The changing of the optical spectrum of the reactive material allows the spectrometer to detect and measure the metal ion.

Any optical spectroscopy technique can be used as part of the detection system, such as any of those known in the art. In brief, infrared spectroscopy is the absorption measurement of different IR frequencies by a sample positioned in the path of an IR beam. The main goal of IR spectroscopic analysis is to determine the chemical functional groups in the sample. Different functional groups absorb characteristic frequencies of IR radiation. IR spectra are obtained by detecting changes in transmittance (or absorption) intensity as a function of frequency.

UV/Vis spectroscopy is the absorption measurement of different ultraviolet and visible frequencies by a sample positioned in the path of an ultraviolet and visible beam. UV/Vis spectroscopy measures the light change by a sample due to an electronic transition in the material. The UV/VIS spectrometers are compact, low power and are currently used on moorings and gliders. Complexation of Fe and Cu onto the reactive material lead to unique absorption maxima in the visible. For example, Fe-DFB and Cu-DFB have unique absorption maxima (460 nm-Fe; 740 nm-Cu) that offer an alternate means for detection in the UV/Vis spectra.

Most commercial infrared and UV/Vis instruments separate and measure the radiation using dispersive spectrometers or Fourier transform spectrometers. In a typical dispersive IR or UV/Vis spectrometer, radiation from a broad-band source passes through the sample and is dispersed by a monochromator into component frequencies. Then the beams fall on the detector, which generates an electrical signal and results in a recorder response. Fourier transform spectrometers have recently replaced dispersive instruments for most applications due to their superior speed and sensitivity. Instead of viewing each component frequency sequentially, as in a dispersive IR spectrometer, all frequencies are examined simultaneously in Fourier transform infrared (FTIR) spectroscopy. The three basic spectrometer components in an FT system are a radiation source, an interferometer and a detector.

Specular reflectance is a mode of IR or UV/Vis spectroscopy that involves a mirrorlike reflection and produces a reflection-absorption spectrum for a surface film of the sample on a reflective surface. Diffuse reflectance is another mode of IR or UV/Vis spectroscopy in which IR radiation is focused onto the surface of a sample and results in two types of reflections: specular reflectance, which directly reflects off the surface and has equal angles of incidence and reflectance, and diffuse reflectance, which penetrates into the sample, then scatters in all directions. Reflection accessories are designed to collect and refocus the resulting diffusely scattered light while minimizing the specular reflectance which distorts the IR or UV/Vis spectra. This technique is often called diffuse reflectance infrared Fourier transform spectroscopy (DRIFT).

In photoacoustic spectroscopy (PAS) the modulated IR radiation from an FTIR interferometer is focused on a sample placed inside a chamber containing an IR-transparent gas. IR radiation absorbed by the sample converts into heat inside the sample. The heat diffuses to the sample surface, then into the surrounding gas atmosphere, and causes expansion of a boundary layer of gas next to the sample surface. Thus, the modulated IR radiation produces intermittent thermal expansion of the boundary layer and generates pressure waves which are detected by a microphone.

Emission spectroscopy is another technique in which the sample is heated to an elevated temperature, emitting enough energy in the infrared region to be detected by an FTIR detector. Emission spectral bands occur at the same frequencies as absorption bands.

Attenuated total reflectance (ATR) is another mode of IR spectroscopy in which the sample is placed on the surface of a dense, high refractive index crystal. The IR beam is directed onto the beveled edge of the ATR crystal and internally reflected through the crystal with a single or multiple reflections. The beam penetrates a very short distance into the sample on the surface before the complete reflection occurs. This penetration is called the evanescent wave and typically is at a depth of a few micrometers. Its intensity is reduced (attenuated) by the sample in regions of the IR spectrum where the sample absorbs.

Although the detection system can be used for detecting and measuring metal ions in any type of aqueous medium, in one application it is used for measuring metal ions in seawater. In a particular embodiment, the detection system is effective to measure subnanomolar concentrations of metal ions in seawater samples. The detection system can be installed on an ocean vessel, an ocean platform, or any other location suitable for collecting seawater and measuring the metal ion. The associated apparatus may include any suitable collection device for collecting samples of seawater from the ocean. In a particular embodiment, the apparatus may also include material(s) to acidify the seawater samples so that the measurements can be directly compared to previous measurements by the oceanographic community. Advantageously, in one embodiment the detection system is effective to measure metal ions in acidified seawater samples. However, the detection system can be used to measure metal ions in seawater having any pH, for example a pH within a range of from about 1.7 to about 8.0.

### EXAMPLES

### Example 1

### Iron Detection in Seawater Using a DFB Modified Chip and Transmission FTIR Spectroscopy

In this example, silicon chips were coated with a film of mesoporous silica. The DFB was anchored to the surface of the film using a silane linker molecule. The chips were then used to detect and measure iron in seawater.

Preparation of the DFB Modified Chips

The mesoporous silica was prepared by combining water, ethanol, HCl and TEOS in an acid-washed flask. The mixture was stirred and refluxed. 10 mL of sol was then added to 20 g ethanol, 0.1 mL 1M HCl, 1.75 g water and 1.3 g CTAB to template a cubic 3D sol gel. This solution was aged in a covered Erlenmeyer flask prior to use.

A 4 inch silicon wafer 2 mm thick was used as substrate for the metal ion detection system. Both sides of the wafer were irradiated with UV light (254 nM) for 45 minutes and exposed to 30% H₂O₂ for 10 minutes to generate an organic-free oxide layer. After the initial cleaning, the wafer was immediately placed in a spin coater, and securely held in place by vacuum. The surface of the wafer was then rinsed with methanol and spun dry. Once dry, approximately 5 mL of the aged sol gel was added to the wafer dropwise and spun at 3000 rpm for 45 seconds. The film was then calcined at 450° C. in a baffle furnace for 3 hours. The coating procedure was then repeated for the other side of the wafer.

The silica-coated wafer was modified to contain anhydride groups through a base catalyzed reaction between an anhydride silane and the isolated silanol groups on silica by immersing the wafer in 100 mL toluene and 2 mL ethylene diamine (EDA) and stirring for 10 minutes at room temperature. The wafer was then immersed in a solution of 100 mL toluene and 2 mL anhydride silane for one hour under nitrogen at room temperature. The anhydride-modified wafer was then thoroughly rinsed with toluene and dried under N₂. The anhydride modified wafer was immersed in water for 15 minutes to convert the anhydride group to carboxylic acid groups that can form an amide bond with the amine tail of DFB using 1-Ethyl-3-[3-dimethylaminopropyl]-carbodiimide hydrochloride (EDC) as a zero length coupling agent.

FTIR Spectroscopy

Transmission FTIR was used to monitor the surface reactions during DFB attachment to the silica coated chip, as well as for Fe quantification. The spectra shown here are difference spectra, using a silica-coated silicon wafer as a reference. A Teflon vessel securely held the chips in the infrared beam without exposing them to contaminating metal surfaces.

Chip Exposure to Fe Containing Samples

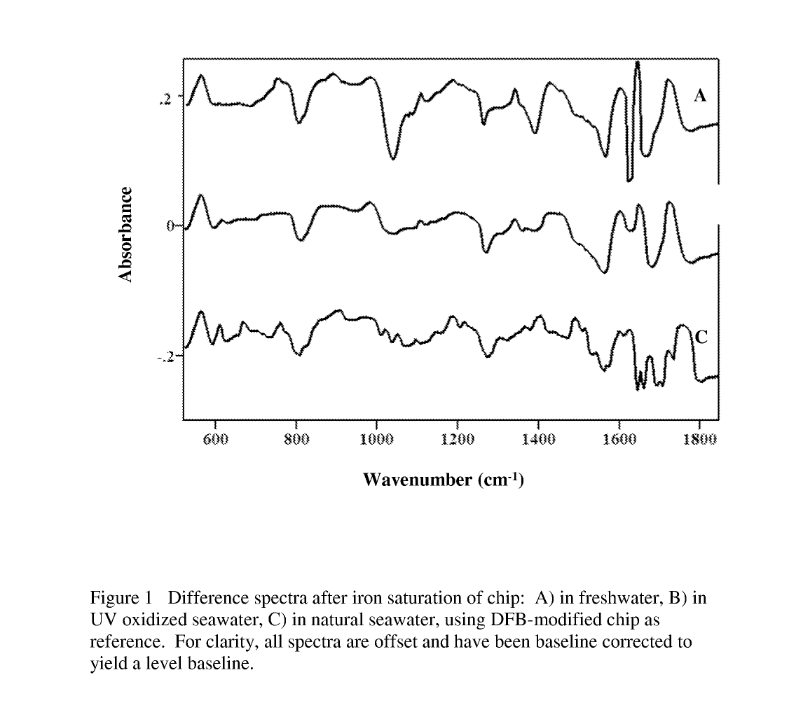

The chips were exposed to samples and standards by suspending a chip in 1 L of stirring solution for 8 hours FIG. 1A shows the difference spectrum of the chip after Fe exposure in freshwater, in the 500-1800 cm⁻¹ range. The spectrum of the chip after exposure to Fe containing seawater is shown in FIGS. 1B (UV-oxidized seawater) and 1C (natural seawater).

Iron Determination Using Chemometric Signal Processing and Detection Limits

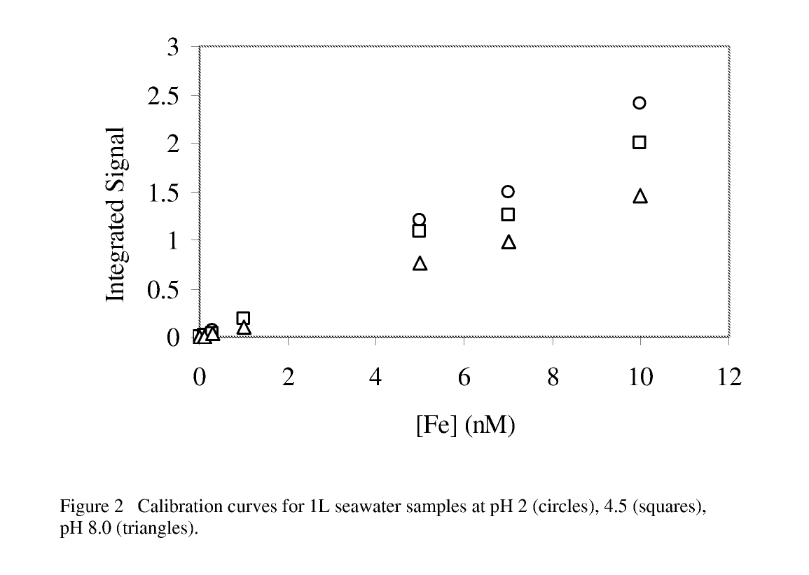

The mass of Fe on the chip's surface in samples was proportional to the size of the Fe—O peak at 560 cm⁻¹ in the difference spectrum, using an unexposed DFB-modified chip as a reference. However, monitoring any peak or combination of peaks in the infrared spectrum can also be used to determine Fe concentrations. A standard curve was used to calibrate the chips in 1 L synthetic freshwater samples while standard additions were performed in low Fe seawater (1 L volume) to determine the system response in a saline matrix (FIG. 2). Both curves were linear from 0-10 nM Fe(III), with nearly identical slopes, and the detection limit (defined as 3×SD of blank replicates) was 36 pM for 1 L freshwater samples and 48 pM for 1 L seawater samples.

Regeneration of Iron-Sensitive Surface

To regenerate the iron-free DFB surface, the chips were thoroughly rinsed with methanol, rinsed thoroughly with 0.01 M HCl and deionized water and were soaked in 10 mM oxalic acid solution (pH 3.0) to release iron from DFB. After a final rinse with deionized water, the chips were dried with N₂ and stored dry.

System Accuracy in Certified Standards

The accuracy of the system was determined by measuring Fe in a number of certified seawater samples. A summary of these results is shown below in Table 3.

TABLE 3
Comparison of Certified Fe samples measured
by Chip based detection system

| Sample | [Fe] accepted (nM) | [Fe] measured (nM) |
|---|---|---|
| NASS-5 | 3.71 +/− 0.63 | 3.58 +/− 0.21 |
| SAFe D2 | 0.91 | 1.07 +/− 0.14 |
| SAFe S1 | 0.091 | 0.100 +/− 0.011 |

System Accuracy in Field Samples

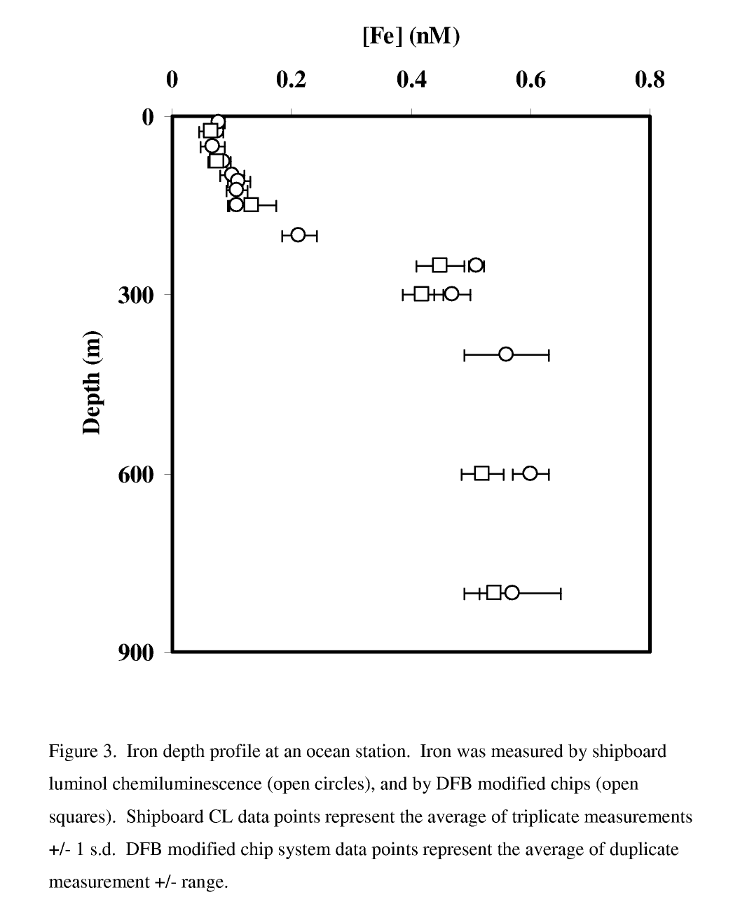

The depth profile from an ocean station is shown in FIG. 3, with samples measured by the DFB modified chip system and by luminol chemiluminescence. Iron values generated by the DFB modified chip system are within 10% of values determined by shipboard analysis.

### Example 2

### Detection of Other Metal Ions Using a DFB Modified Chip and Transmission FTIR Spectroscopy

The infrared signatures of other metal ions in seawater were determined by exposing the DFB modified chips to 1 L solutions containing Mn, Co, Ni, Cu, Zn for 8 hours. Following sample exposure, the chips were dried and analyzed using transmission FTIR. The bands associated with each metal ion in the 450 and 650 cm⁻¹ region are listed in Table 2, along with typical concentrations in seawater and the concentration of sample that they were tested at. Table 2 lists a limited number of metal ions; however any metal ion that has a unique infrared signature can be analyzed in this manner. Although Table 2 lists a single unique peak for each metal ion, any unique band in the spectral signature can be used for metal ion determinations.

TABLE 2
List of some metal ions found to cause a unique
infrared signature on DFB modified chips

| | Typical Seawater | Tested | Peak |
|---|---|---|---|
| Element | Concentration (M) | Concentration (M) | (450-650 cm⁻¹) |
| Mn²⁺ | 5 × 10⁻¹⁰ | 1 × 10⁻⁹ | 595 |
| Co²⁺ | 2 × 10⁻¹¹ | 1 × 10⁻¹⁰ | 600 |
| Ni²⁺ | 8 × 10⁻⁹ | 1 × 10⁻⁸ | 629 |
| Cu²⁺ | 4 × 10⁻⁹ | 1 × 10⁻⁸ | 610 |
| Zn²⁺ | 6 × 10⁻⁹ | 1 × 10⁻⁸ | 633 |

### Example 3

### Demonstration that Bulk Salts do not Interfere with Metal Ion Measurement by DFB-Modified Chips and Transmission FTIR

A seawater matrix is full of cations that could bind to unoccupied DFB sites and could potentially interfere with metal ion analysis. To explore this possibility, chips were exposed to salt solutions at or above seawater concentrations to look for any peaks that might interfere with metal ion analysis. A summary of this work is shown in Table 3:

TABLE 3
Salts tested for possible interferences with metal ion analysis
using DFB modified chips and transmission FTIR.

| | Typical Seawater | Tested | Peak |
|---|---|---|---|
| Element | Concentration (M) | Concentration (M) | (450-650 cm⁻¹) |
| Na⁺ | 0.47 | 1 | N/A |
| Mg²⁺ | 5 × 10⁻² | 5 × 10⁻² | N/A |
| Ca²⁺ | 1 × 10⁻² | 1 × 10⁻² | N/A |

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A detection system for detecting and measuring a metal ion in an aqueous medium comprising:
a substrate providing mechanical stability and sized and shaped to intercept an optical beam;
a reactive material attached to the substrate, the reactive material capable of reacting with the metal ion and changing its optical spectrum upon reacting;
an optical spectrometer producing the optical beam that passes through the reactive material to a detector of the spectrometer, the changing of the optical spectrum of the reactive material allowing the spectrometer to detect and measure the metal ion.

2. The detection system of claim 1 wherein the reactive material comprises a chelator that bonds to the metal ion to form a chelate complex.

3. The detection system of claim 2 wherein the metal ion comprises iron.

4. The detection system of claim 3 wherein the iron chelator comprises a siderophore.

5. The detection system of claim 1 wherein the substrate comprises a chip.

6. The detection system of claim 5 wherein the chip comprises a silicon chip.

7. The detection system of claim 5 wherein the substrate further comprises a coating on the chip to which the reactive material is attached.

8. The detection system of claim 7 wherein the coating includes functional groups to which the reactive material is attached.

9. The detection system of claim 8 wherein the coating comprises mesoporous silica.

10. The detection system of claim 1 wherein the substrate is at least partially transparent to the optical beam.

11. The detection system of claim 1 wherein the optical spectrometer comprises an infrared spectrometer.

12. The detection system of claim 11 wherein the infrared spectrometer comprises a fourier transform infrared spectrometer.

13. A detection system for detecting and measuring a metal ion in an aqueous medium comprising:
a disposable substrate providing mechanical stability and sized and shaped to intercept an optical beam;
a reactive material attached to the substrate, the reactive material capable of reacting with the metal ion and changing its optical spectrum upon reacting;
an optical spectrometer producing the optical beam that passes through the reactive material to a detector of the spectrometer, the changing of the optical spectrum of the reactive material allowing the spectrometer to detect and measure the metal ion.

14. The detection system of claim 1 wherein the disposable substrate comprises a silicon chip.

15. An apparatus for detecting and measuring a metal ion in seawater comprising:
a substrate providing mechanical stability and sized and shaped to intercept an optical beam;
a reactive material attached to the substrate, the reactive material capable of reacting with the metal ion and changing its optical spectrum upon reacting;
a sample collector for collecting a sample of seawater from an ocean, the seawater sample to be exposed to the reactive material on the substrate; and
an optical spectrometer producing the optical beam that passes through the reactive material to a detector of the spectrometer, the changing of the optical spectrum of the reactive material allowing the spectrometer to detect and measure the metal ion;
the apparatus adapted for use on an ocean vessel or an ocean platform.

16. The apparatus of claim 15 which is effective to detect and measure subnanomolar concentrations of the metal ion in seawater samples.

17. The apparatus of claim 15 further comprising a material to acidify the seawater sample, the apparatus being effective to detect and measure the metal ion in the acidified seawater sample.

18. The apparatus of claim 15 wherein the reactive material comprises a chelator that bonds to the metal ion to form a chelate complex.

19. The apparatus of claim 15 wherein the metal ion comprises iron.

20. The apparatus of claim 15 wherein the substrate comprises a transportable and disposable chip.
